(19) United States
(12) Patent Application Publication
(10) Pub. No.: US 2010/0011504 A1
(43) Pub. Date: Jan. 21, 2010

(54) OPERATING TABLE GUIDE DEVICE CONSISTING OF GUIDE ARMS DESIGNED TO BE FIXED IN DETACHABLE FORM ON THE AFOREMENTIONED TABLE AND OPERATING TABLE COMPRISING SUCH GUIDE ARMS

(75) Inventors: Jean-Marie L'Hegarat, Olivet (FR); Olivier Collot, Orleans (FR); Filipe Franco, Saint-Jean-De-Braye (FR)

Correspondence Address: HARNESS, DICKEY & PIERCE, P.L.C., P.O. BOX 828, BLOOMFIELD HILLS, MI, 48303, US

(73) Assignee: STERIS SURGICAL TECHNOLOGIES, Saran (FR)

(21) Appl. No.: 12/301,305

(22) PCT Filed: Apr. 19, 2007
(86) PCT No.: PCT/FR2007/000657

§ 371 Date: Mar. 26, 2009

(30) Foreign Application Priority Data
May 18, 2006 (FR) 0604464

(51) Int. Cl. A61G 13/02; A61G 13/10

(52) U.S. Cl. 5/600

(57) ABSTRACT

The invention concerns a guiding device for a mobile operating table comprising at least one lateral rail for accessories, the aforementioned device comprising at least one guiding arm stretching along an axis and presenting an extremity fitted with a fastening mechanism permitting a detachable fixing of the aforementioned guide arm on the rail of the operating table, characterized in that the fastening means consist of at least one notch oriented along an axis substantially perpendicular to the axis of the guiding arm, said notch being capable of accommodating a spacer linking the side rail to the operating table, and a blocking element configured to block the guide arm on the rail by pressure of the aforementioned blocking element.

### CROSS-REFERENCE TO RELATED APPLICATIONS

This application is a National Phase Entry of International Application No. PCT/FR2007/000657, filed Apr. 19, 2007, claiming priority to French Patent Application No. 06/04464, filed May 18, 2006, both of which are incorporated by reference herein.

### BACKGROUND AND SUMMARY

The invention relates to the field of operating tables, more particularly intended for surgical operations.

During surgical operations, patients have to be transferred from place to another and more particularly from the induction room to the operation room, where they have to undergo the surgical intervention, and from the operation room to the recovery room. The transfer of the patients is conventionally performed using transport trolleys which are manually pushed by the medical staff. They are transferred from their beds to the transport trolley to be brought to the operating room, where they are transferred from the transport trolley to the operating table. Such patients' transfers thus remain relatively not easy and entail, for the medical staff, injury hazards, and for the patient risks of worsening of injuries.

In an attempt to remedy the drawbacks related to such patients' transfers, operating tables have been proposed having an additional “transfer” functionality, i.e. making it possible to carry the patient from his or her bed and back to his or her bed after the surgical operation without having to use to a transport trolley. For example, a top of an operating table removably connected to a trolley is known as an application for the European patent EP0917868. Advantageously, the top is successively transferred from the mobile trolley to a fixed base, and reversely. Although the transfer of the patient onto the operating table is not only carried out with the direct handling of the patient, the system described however requires some physical strength to be able to move the top from one support to another. Such a system has, in addition, the drawback of being relatively difficult to handle.

A motor-driven operating table controlled by a handlebar composed of two guiding arms intended to be respectively attached on either side of the table is also known from the application for the European patent EP1530959. More particularly, said guiding arms are removably attached on the side rails of the table, said rails being used as accessory holders. Said handlebar further includes control means making it possible to control the operation of the starting or the shutdown of the motor, as well as the motion of the table (forward operation and/or backward operation). However, the described handlebar reveals to be inappropriate for being used on an operating table having the transfer functionality, because of some of the characteristics thereof.

One of the first drawbacks of such a handlebar is related to the fact that it is mounted on the operating table. The mounting is carried out according to a motion performed above the top and more particularly above the patient's head which lies on the table. Now, when the patient is connected to breathing assistant systems (mask, . . . ) or to any other medical systems, the access to the handlebar can be limited. In addition, such a gesture may be felt as frightening or even terrorising for the patient who is lying on the table.

A second drawback of said handlebar is related to the rigid constitution thereof. Such a constitution implies a precise and simultaneous engagement of both arms composing the handlebar onto their respective side rails. Such a gesture is in fact difficult and relatively fastidious, since the handling person generally has to repeat it several times before placing the arms of the handlebar on the rails.

Another drawback is connected to the fixed position of the handlebar with respect to the top of the table supporting the patient. As a matter of fact, the handlebar is fixedly held in the extension of the top supporting the side rails which it is mounted on. In fact, the top acts as a back. Thus, such a handlebar cannot be used for operating tables where the top composing the back is lifted up to allow the patient to sit up. The utilisation of the handlebar thus implies that the table is held, as a whole, substantially horizontal, and the table can then be adjusted in height between each operation.

Another drawback of the handlebar is connected to the fixed spacer between the two arms. As a matter of fact, as it is rigid, the handlebar cannot be mounted but on one part of the table, the inter rails distance of which is fixed. Therefore, the handlebar is limited to an installation on either side i) of the top composing the back of the table, ii) or of the top or tops, which act(s) as the leg holders.

In addition, in the previous patent application, the handlebar is relatively protruding with respect to the operating table, which can be an obstacle for the patient's transfer from his or her bed to the operating table and back. As a matter of fact, the width of the handlebar, which is greater than that of the table, makes it impossible to place the operating table close enough to the patient's bed. Eventually, a last drawback of the handlebar appears upon the retrieval thereof from the operating table. As a matter of fact, because of its shape, the major part of the mass of the handlebar is positioned on the motor control means side. Upon the retrieval thereof from the table, the natural handling is in the middle of the arms of the handlebar, with the head of the handlebar carrying the control means being driven downwards in a sudden rotating motion.

The invention more particularly aims at remedying the drawbacks of the system previously described by providing a removable guiding device for an operating table making it possible to simply fix the guiding arm while remaining secure so as to facilitate the mounting and dismounting of said guiding device on and from the table. The invention also aims at providing a multi-purpose and adaptable guiding device making it possible to remedy the possible dimensional differences between the operating tables, and making it possible for it to be fixed at the front as well as at the back of the tables.

For this purpose and according to a first aspect, the invention relates to a guiding device for a mobile operating table comprising at least one side rail for accessories, said device comprising at least one guiding arm extending along an axis AA1 and having an end provided with fastening means enabling a removable fastening of said guiding arm on the rail of the operating table, characterized in that the fastening means comprise:

at least one notch oriented along the axis BB1 substantially perpendicular to the axis AA1 of the guiding arm, such notch being capable of receiving a spacer connecting the side rail to the operating table, and
a blocking element so configured as to block the guiding arm on the rail by pressing said blocking element on said rail,
said notch and said blocking element being so arranged as to allow, when the spacer is positioned in the notch, the pivoting of the guiding arm about the spacer and until said blocking element is in contact with said rail.

Thus, the blocking of the guiding device on the operating table is obtained through the balance of the forces exerted between the spacer integral with the rail and accommodated in the notch and the blocking element held pressed against the rail. Thus, there is no real fastening, since the fastening is obtained simply because of a “mingling” about the spacers of rails and the rails proper, and the blocking being obtained by gravitation. Thus, when the arm or arms is/are pulled or pushed, the spacers which are integral with the table are in fact forced. Advantageously, the blocking element is formed by a leg extending along an axis substantially parallel to the axis BB1 of the notch, and so arranged with respect to said notch as to prevent the pivoting beyond the horizontal position of the guiding arm about the spacer.

According to a particular configuration of the invention, the fastening means consist of a part comprising a front side edge and a rear side edge, said front side edge being extended by an upper edge slightly sloping downwards, said upper edge being extended by the rear side edge. In this configuration, and advantageously, the notch is located on the upper edge of said part and the blocking element is located close to the junction of the front side edge and the upper edge. In order to improve the blocking of the guiding arm on the rail, the notch can be provided substantially circular and including a rear side wall having the shape of a hook. Advantageously, the fastenings means are positioned in the spaced defined by the rail and the operating table, and for this purpose, have dimensions allowing such insertion.

According to a particularly advantageous configuration of the configuration, the fastening means are mounted for pivoting on the end of the guiding arm according to an axis substantially parallel to the axis BB1 of the notch, by means of a cylinder so as to allow the passage to the guiding arm from the horizontal position to a position sloping downwards, with the cylinder being advantageously arranged to as to enable a sloping of the guiding arm with respect to the plane of the table up to −90 degrees. This characteristic is particularly advantageous when the top of the operating table is formed by a juxtaposition of mobile parts with respect to each other. As a matter of fact, it makes it possible to hold the guiding arms in a horizontal plane, whatever the slope given to the mobile part of the top, where said guiding arms are fastened. More particularly when the part of the top forming the back is lifted up by 90 degrees, said guiding arms are lowered by 90 degrees so as to be in a horizontal position.

In the configuration where the guiding device includes two guiding arms, it will be advantageous to provide these integral with each other so as to enable a side flexion of each of said arms. This flexion should be sufficient to enable the insertion of the fastening means of each guiding arm into the space provided between the rails and the operating table.

According to a second aspect, the invention relates to an operating table including a top for supporting a patient, said top being fixedly mounted on a wheeled trolley including at least two side rails for accessories positioned on either side of the top, as well as a guiding device such as previously described. Advantageously, the operating table is a motor-driven table.

### BRIEF DESCRIPTION OF DRAWINGS

Other objects and advantages of the invention will appear when reading the following description, while referring to the appended drawings, where:

FIG. 1 illustrates a partial perspective view of an operating table provided with a guiding device according to the invention, the guiding device being positioned on the front part of the table;

FIGS. 2a and 2b illustrate the mounting of the guiding device on the operating table of FIG. 1;

FIGS. 3a and 3b are detailed views of FIGS. 2a and 2b illustrating the mounting and the fixing of the guiding device on the operating table, and FIG. 3c is a partial schematic representation of the motion of the guiding device upon the positioning thereof on the operating table;

FIG. 4 illustrates a view of the operating table showing the top where the guiding device is fastened in a sloping position;

FIGS. 5a and 5b illustrate a partial constructional view of the guiding device fixed on the rail, and moving from a horizontal position to an inclined position; and

FIG. 6 illustrates a partial perspective view of an operating table provided with a guiding device according to the invention, said guiding device being positioned, for example, on the rear part of the table forming the leg holders.

### DETAILED DESCRIPTION

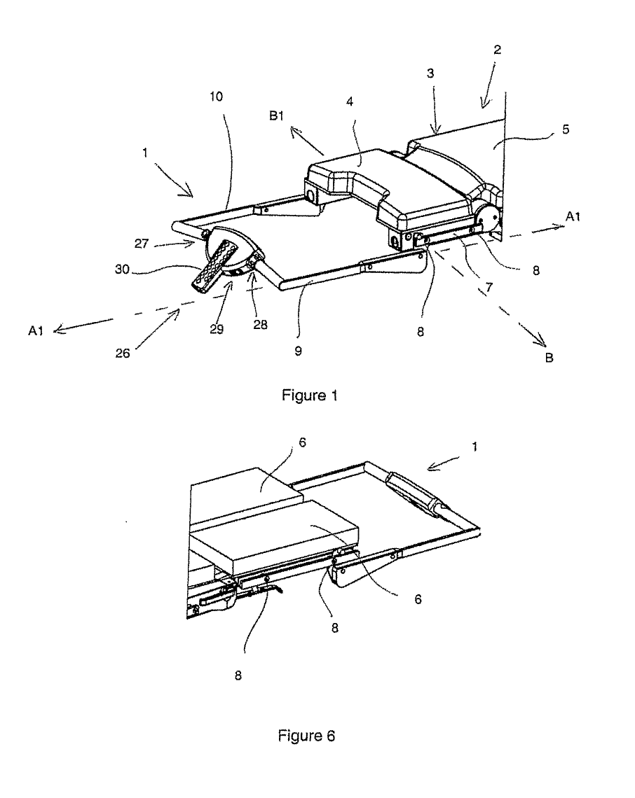

While referring to FIGS. 1 to 6, a guiding device 1 which is removably fixed on an operating table 2 intended more particularly to surgical operations is described. Said operating table 2 is of the type including a top 3 for supporting a patient, fixed on a wheeled trolley (not shown). Advantageously, the top 3 of the operating table 2 is obtained by juxtaposing three parts 4, 5 and 6 intended to respectively receive the top of the back, the bottom of the back and the hips, as well as the legs of the patient. The operating table 2 further includes side rails 7, which are fixed on the side edges of the top 3, and more particularly on the side edges of each part 4 to 6 through spacer 8. The rails 7 thus positioned around the top 3 make it possible to hang accessories required by the surgeon during the surgical operation.

The guiding device 1 according to the invention includes two guiding arms 9 and 10 extending in the same plane and symmetrical with respect to each other in a longitudinal direction. In order to simplify the reading of the description, the structure of the guiding arm 9 will only be described, the other guiding arm 10 being symmetrical to said guiding arm 9. The guiding arm 9 has a free end provided with fastening means 11 enabling the removable fastening on either side of the operating table 2 on the rail 7.

The fastening means 11 are composed of one part 12, having a low thickness, and being substantially triangular. They are dimensioned so as to enable the insertion thereof into the space defined by the rail and the operating table. More particularly, said part 12 includes an outer face 13 and an inner face, and three edges: an upper edge 14 composed of the upper edge of the part 12, a front side edge 15 and a rear side edge 16. The terms “outer face” and “inner face” mean the faces of the part 12, when it is engaged into the space formed between the top 3 and the side rail 7, respectively positioned towards the rail 7 or towards the top 3. Similarly, the terms “front side edge” or “rear side edge” mean the position of the edges with respect to the guiding arm 9. Advantageously, the junction between each of the edges is rounded, with a view to avoiding injuries to the user of the operating table as well as to the patient, more particularly during the handling of the guiding device during the mounting or the dismounting thereof.

The front side edge 15 is positioned substantially perpendicularly to the guiding part 9, the rear side edge 16 being slightly slanted and oriented opposite the front side edge 15. According to the described embodiment, the front side edge 15 has a length greater than that of the rear side edge 16, so that the upper edge 14 is also slightly sloping. The upper edge 14 is provided with a notch 17 oriented along an axis BB1 substantially perpendicular to the plane of the part 12. As will be described in the following, said notch 17 is so configured as to receive one of the spacers connecting a side rail 7 to the operating table 2. Said notch 17 includes a bottom 18 which is substantially circular and two side walls, a front side wall 19 and a rear side wall 20 having the shape of a hook. As will be seen in the following, the front side wall 19 acts as a spacer stop 25.

The outer face 13 of the part 12 further includes an extension which acts as a bearing lug 21 intended to block the guiding device 1 on the side rails 7 of the operating table 2. In the described embodiment, the bearing lug has a substantially circular cross-section. It should be noted that this configuration is given as an example and that said bearing lug may have other shapes of cross-sections without leaving the scope of the present invention.

According to the embodiment described, the bearing lug 21 is formed on the outer face 13, close to the junction of the front side edge 15 and the upper edge 14 of the part 12. Advantageously, the bearing lug 21 extends perpendicularly to the part 12, so as to have an axis substantially parallel to the axis of the spacer which will be received in the notch 17 (or the axis BB1 of the notch 17). The bearing lug 21 will further be so dimensioned as to be pressed on the upper surface of said rail 7 when the guiding arm 9 is inserted into the space formed between the top 3 and said rail, the notch 17 accommodating the spacer 8 of the relating rail.

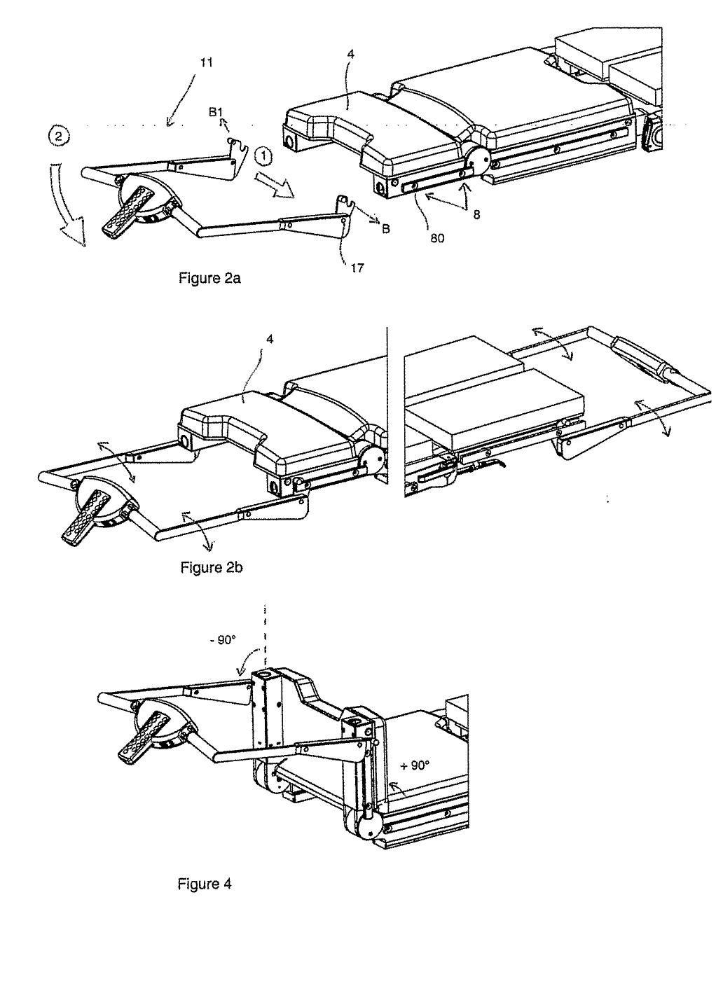

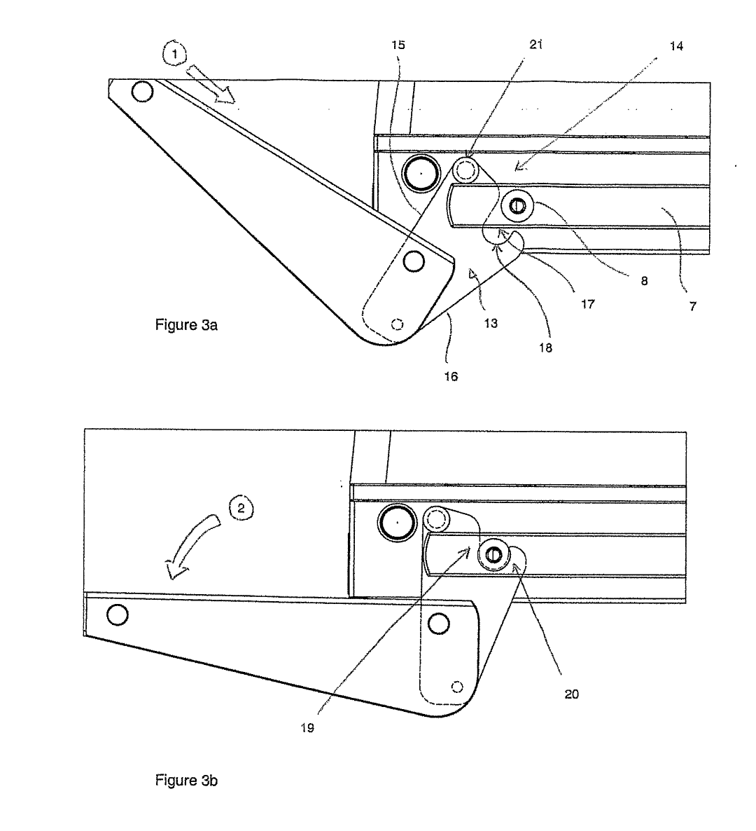

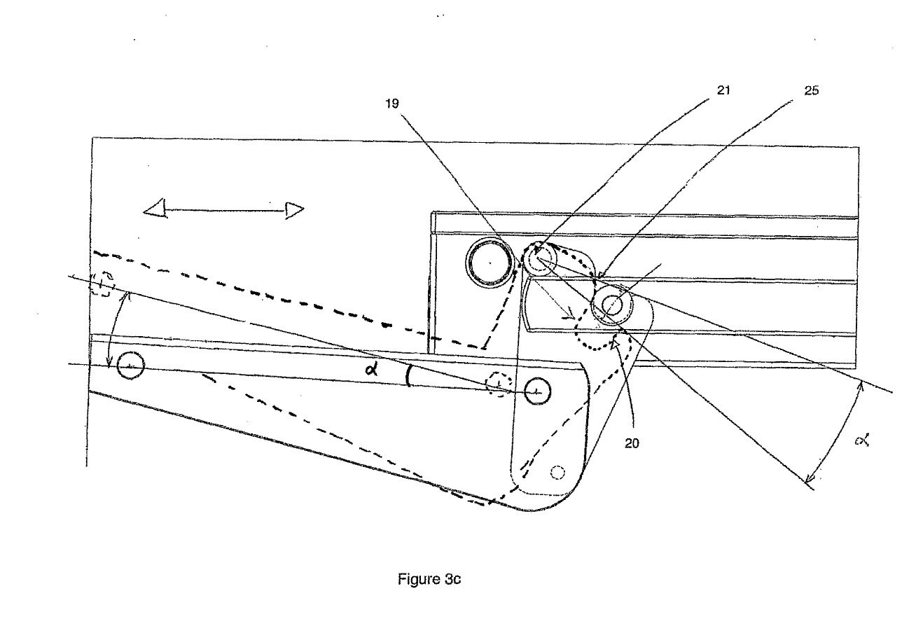

The principle for the fastening of the guiding device 1 according to the invention on the operating table 2 is illustrated in FIGS. 2a, 2b, 3a, 3b and 3c. The guiding device 1 is shown in front of the top 3, with the ends of the guiding arms 9 and 10 carrying the fastening means 11 sloping downwards. The bearing lugs 21 of the guiding means 9 and 10 are so positioned as to rest on the side rails 7. The guiding arms 9 and 10 are then pushed into the space formed between the concerned part 4 of the top 3 and the side rails 7 which are associated therewith, the bearing lugs 21 sliding on the rails 7 until the front side wall 19 of each notch 17 comes into contact with the end spacer 80 connecting the rails 7 with part 4 (motion illustrated in FIG. 3c by a double arrow).

According to a particularly advantageous configuration of the invention, the guiding arms 9 and 10 are made integral with each other, so as to enable a side flexion of each of said arms. Thus, when acting on the flexion of the guiding arms 9 and 10, the spacing between said arms is adapted to the inter-rails spacer which can vary from an operating table to another. The flexion of the arms further provides the advantage of enabling the fastening thereof, as well at the level of the part 4 of the top (refer to FIG. 1), or of the part 6 of the top which acts as the leg holders (refer to FIG. 6). And it is possible to move the table by driving it as well from the patient's head side as from the feet side. This characteristic makes it possible to adapt the transport of the patient to specific needs. For example, it may be advantageous in some situations to move the operating table 2 via a guiding device 1 fixed at the level of the feet, so as to be able to leave the patient's head close to the wall, in the recovery room, for example, and thus close to the medical assistance facilities.

When the front side walls 19 of each notch 17 are in abutment against the spacers 80, the guiding arm 9 and 10 are released. This action entails that said guiding arms 9 and 10 are lowered until they reach a substantially horizontal position. The blocking in this position is then obtained through the joint action of the bearing lugs 21 and the rear side wall 20 of the notches having the shape of a hook, since no stress is exerted then. As a matter of fact, the lowering of the guiding arms 9 and 10 leads to a pivoting motion of the later about the bearing lugs 21 which motion results in that the hooks are positioned about the corresponding spacers 80. The height of the hooks is an essential feature for the hanging of the guiding arms 9 and 10. As a matter of fact, the height determines the mounting and dismounting angle of said guiding arms 9 and 10 (angle α).

The fastening of the guiding arms 9 and 10 on the side rails is thus obtained through a “mingling” about the rail spacers and the rails proper. As for the blocking, it is obtained by gravitation. The fastening will be further improved by the slightly curved shape of the notch 17 (hook) which composes the fastening means. Then, the effort is exerted directly on the spacers which are integral with the table, when the guiding arms 9 and 10 are pulled or pushed. The removal of the guiding arm 9 and 10 will be obtained similarly with a reverse motion.

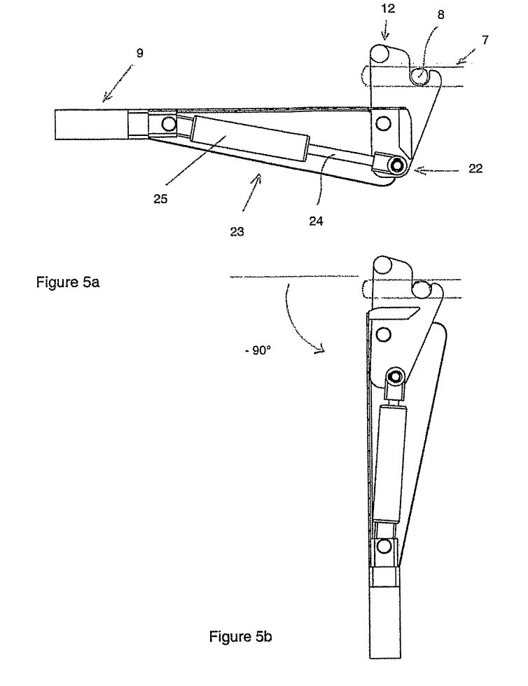

In order to enable the adjustment of the position of the guiding arms 9 and 10 to the user's size, and also to be able to use the guiding device 1 on an operating table 2 where the patient is in a sitting position, i.e. where one of the parts of the top 3 of the table has been lifted up, the possibility of adjusting the height of the position of the guiding arms 9 and 10 with respect to the operating table 2, as illustrated in FIGS. 4, 5a and 5b, is advantageously provided for. For this purpose, the part 12 is mounted articulated on the end of the guiding arm about an axis perpendicular to the part 12. This hinge 22 is controlled by a cylinder 23, one end of which carries the piston 24 and is fixed to the part 12 at the level of the joint 22, with the other end carrying the cylinder 25 and being mounted for pivoting on the end of the guiding arm 9. Then, the cylinder 22 enables the passage of the guiding arm from the horizontal position with respect to the plane of the operating table 2, in which it is kept through the blocking of the bearing lug 21, to a downward sloping position.

Advantageously, the cylinder 23 is so arranged as to enable the stopping of the guiding arm with respect to the plane of the operating table 2 included in the solution provided between 0 degree and −90 degrees. It should be noted that this chosen angular motion of the guiding arm results from the configuration of the implemented fastening means and the principle of the fastening selected for the guiding arm on the operating table. Advantageously, the system lifting up the handle bar can be slowed in order to improve the utilisation ergonomics. Advantageously, the cylinder 23 can be a simple gas cylinder slowly returning the guiding arm 9 as soon as the lowering effort on the latter has ceased, or a blocking gas cylinder in which the guiding arms 9 and 10 are kept in the sloping position in which they have been left.

According to a particular aspect of the invention, the operating table 2 is motor-driven. The guiding device will advantageously comprise a control block 26 making it possible to control the motion of said operating table 2, with the control arms 9 and 10 extending on either side of this control block 26. For this purpose, the control block 26 is coupled to a base positioned under the table 2 and comprises an engine block. Said base is a part of the frame supporting the top 3.

The words “controlling the motion of the operating table” means the starting and the stopping of the motor, the control of the front operation or rear operation of the table as well as the control of the speed motion of said table 2. These actions are obtained by means of specific control buttons 27, 28 and 29.

Advantageously, the control block 26 is associated with the remote control device 30 making it possible to control the position of the operating table 2 and more particularly to adjust the positions of the various parts composing the top 3 of the operating table 2. According to a specific configuration of the invention, said control block 26 includes a housing so configured as to removably receive said remote control device 30. Said housing is provided with connections matching the connections of the remote control device. Advantageously, said remote control device 30 can be interconnected and is interchangeable.

The guiding device 1 including a control block 26 and the remote control device 30 has a balanced shape to prevent the rotation motion observed on the systems of the prior art when they are dismounted from the operating tables. The invention has been described hereabove as an example. Of course, the persons skilled in the art will have the possibility of making various modifications without leaving the scope of the invention.

1. A guiding device for a mobile operating table including at least a side rail for accessories, said device comprising at least one guiding arm extending along a first axis and having an end provided with a fastener assembly operably allowing a removable fastening of said guiding arm on the rail of the operating table, the fastener assembly further comprising:
at least one notch oriented along a second axis substantially perpendicular to the first axis of the guiding arm, said notch being capable of receiving a spacer connecting the side rail to the operating table; and
a blocking element configured for blocking the guiding arm on the rail by pressing said blocking element on said rail;
said notch and said blocking element being so arranged as to enable, when the spacer is positioned in the notch, the pivoting of the guiding arm about the spacer until said blocking element is in contact with said rail.

2. A guiding device according to claim 1, wherein the blocking element comprises a leg extending along an axis substantially parallel to the axis of the notch, and so arranged with respect to said notch as to prevent the pivoting beyond a horizontal position of the guiding arm about the spacer.

3. A guiding device according to claim 1, wherein the fastener assembly further includes a part comprising a front side edge and a rear side edge, the front side edge being extended by an upper edge slightly sloping downwards, said upper edge being extended by the rear side edge.

4. A guiding device according to claim 3, wherein the notch is located on the upper edge of said part, the blocking element being located close to the junction of the front side edge and the upper edge.

5. A guiding device according to claim 1, wherein the notch, which is substantially circular, comprises a rear side wall in the form of a hook.

6. A guiding device according to claim 1, wherein said fastener assembly is so dimensioned as to allow the insertion thereof into the space defined by the rail and the operating table.

7. A guiding device according to claim 6, wherein the fastener assembly is mounted for pivoting on the end of the guiding arm, along an axis substantially parallel to the second axis of the notch, by a cylinder so as to enable the passage of the guiding arm from the horizontal position to a downward sloping position.

8. A guiding device according to claim 7, wherein the cylinder is so arranged as to enable the sloping of the guiding arm with respect to the plane of the table between 0 degrees and −90 degrees.

9. A guiding device according to claim 1, wherein there are two guiding arms made integral with each other, so as to enable a side flexion of each of said arms sufficient to enable the insertion of the fastener assembly of each guiding arm into the space provided between the rails and the operating table.

10. An operating table comprising a top for supporting a patient, said top, rigidly mounted on a wheeled frame, including at least two side rails for accessories positioned on either side of the top as well as said guiding device according to claim 1, said guiding device being movably fastened on the side rails.

11. An operating table according to claim 1, wherein the table is motor-driven.
